(19) United States
(12) Patent Application Publication
(10) Pub. No.: US 2023/0334709 A1
(43) Pub. Date: Oct. 19, 2023

(54) Lidargraph

(71) Applicant: The Indoor Lab, LLC, San Juan Capistrano, CA (US)

(72) Inventors: Mark Punak, San Clemente, CA (US); Patrick Blattner, Dana Point, CA (US)

(73) Assignee: The Indoor Lab, LLC, San Juan Capistrano, CA (US)

(21) Appl. No.: 18/136,475

(22) Filed: Apr. 19, 2023

Related U.S. Application Data
(60) Provisional application No. 63/332,469, filed on Apr. 19, 2022.

(51) Int. Cl. G06T 7/11; G06T 9/00; G06T 7/73

(52) U.S. Cl. CPC G06T 9/00; G06T 7/11; G06T 7/73; G06T 2207/10028

(57) ABSTRACT

The invention provides a method of lossless compression of a file of lidar point cloud data which have the steps of providing a file of lidar data, representing a predetermined number of frames of raw lidar data, with a set of objects identified and classified within the lidar data. Each identififed object in the lidar point cloud data is assigned an objectId to allow tracking of each identified object’s position in each frame of the point cloud data. For each frame of lidar point cloud data, sequencing the position of each identified object in that frame based on each objects order of appearance in a bounded grid applied to each frame, reading from right to left, top to bottom, with each identified objects position described as their integer offset from the previous identified object in the bounded grid, so that each identified objects offset value is stored in the compressed file as a variable width integer datatype.

### CROSS-REFERENCE TO RELATED APPLICATIONS

This application claims priority to provisional application no. 63/332469, filed Apr. 19, 2022, the entire contents of which are hereby incorporated by reference.

### STATEMENT REGARDING FEDERALLY SPONSORED RESEARCH

Not Applicable

### FIELD OF THE INVENTION

The invention relates to a compression method to reduce the filesize for storing the position of identified object data in lidar point cloud data, as well as store object classification, immutable attributes, events and mutable attributes related to the objects. More particularly a lidargraph allows for the compressed storage for object spatial data for each frame of lidar point cloud data.

### BACKGROUND OF THE INVENTION

The increasing use of lidar technology has led to the generation of large amounts of point cloud data that are challenging to store, transfer, and process. Lidar technology can provide precise spatial data for autonomous driving, robotics, and other applications. However, the size of point cloud data can range from a few gigabytes to several terabytes, depending on the resolution, scan angle, and frame rate. In consumer applications, such as gaming, virtual reality, and augmented reality, it is essential to have small file sizes for efficient storage and transfer of lidar data. The LidarGraph compression method enables the compression and storage of large amounts of lidar point cloud data in as small a file as possible, making it easier to replay and use that data in consumer applications.

The problem that is to be solved is that lidar data streams are very large and contain a lot of information that can be excluded from a more simplistic, utilitarian rendering of the data. Even with only needing to track the X and Y coordinates of every tracked object in each frame, the tracked object output stream from the lidar consumes 205 bytes per tracked object, carrying high resolution data for:
Distance from lidar (3 dimensions)
Object size (3 dimensions)
Velocity (3 dimensions)
Other object metadata which mostly remains unchanged during a tracking cycle.

Though this output stream format changes depending on the manufacturer (Velodyne, Quanergy, Cepton, Sol Robotics), the metrics included in each format have a significant overlap.

What is needed is a solution to archive large amounts of time series Lidar data in as small of a file as possible to facilitate the use/replay of that data in consumer applications in much the same way AVI and MP4 facilitate the replay of video data.

The term “Lidargraph” borrows its name from the name from the word “Photograph”. A digital photograph captures light at a moment in time, allowing that information to be rendered as an image into perpetuity. Like a photograph a lidargraph captures and stores 2d or 3d positional information and attributes, like the type of information that might be captured by a Lidar. Although a lidar might be the source of information in a lidargraph, the information could also come from any other source capable of generating spatial data, such as a stereoscopic camera. Unlike a photograph and existing point cloud storage formats such as PCD and PLY, a lidargraph can store multiple frames of 2d or 3d data, allowing those frames to be animated, analogous to how .MOV file stores multiple pictures and audio to form a moving picture with sound over time. Although a lidargraph can store raw point cloud data, each element of positional data contained in each frame is uniquely identified, allowing objects to be attributed and tracked over a time. Events that interact with the objects can be stored and object attributes can be evolved.

2d or 3d space - Points that are tracked can be either 2d (x,y) or 3d (x,y,z) in nature.

Time Series data - Rather than storing a single snapshot of objects in 2d or 3d space at a moment in time, lidargraphs can store data over a span of time, storing object information for all objects in view at a moment in time as a frame of data, containing as many frames as required to cover a timespan as large as may be desired.

Objects - Each point has its own unique object identifier, allowing the movement of an object to be tracked over time as its positional data changes from frame to frame.

Attributes - Each object represented in a lidargraph has at a minimum its own object identifier. Additional objects attributes can be stored and evolved by events Events - The file format support the storage of time related events, usually associated with one or more objects. For example, an event for a car stopped at a curbside might be stored to note the moment the doors of the car opened or closed. Events types and their meanings are not predefined, allowing developers the flexibility of defining what types of events they want to store.

Compression - Lidargraph files compress spatial data by defining the boundaries of the 2d or 3d coordinates contained within the file, voxelizing that space, and storing the indices and offsets of the objects/points visible within that space for each frame. Commercial compression algorithms can then be applied to the already compressed spatial data, yielding a highly compressed spatial data stream.

### BRIEF SUMMARY OF THE INVENTION

The invention provides a method of lossless compression of a file of lidar point cloud data which have the steps of providing a file of lidar data, representing a predetermined number of frames of raw lidar data, with a set of objects identified and classified within the lidar data. Each identififed object in the lidar point cloud data is assigned an objectId to allow tracking of each identified object’s position in each frame of the point cloud data. To reduce the filesize for the compressed file, for each frame of lidar point cloud data, sequencing the position of each identified object in that frame based on each objects order of appearance in a bounded grid applied to each frame, reading from right to left, top to bottom, with each identified objects position described as their integer offset from the previous identified object in the bounded grid, so that each identified objects offset value is stored in the compressed file as a variable width integer datatype.

To further reduce the size of the file, the compressed position data for the objects in each frame is further compressed using an additional lossless compression technique to result in the lidargraph compressed file.

The position of each object can either be 2D or 3D.

The zero based relative offset for the second object position (x2, y2) relative to the first object position (x1, y1) is (20 - x1) + ((y2-y1)-1)*20) + x2, and the zero based absolute offset for the second object position is its relative offset plus the relative offset of the first object position.

Object indexing can be utilized for the first 255 objects to further reduce the lidargraph file size.

Resolution reduction can be utilized to remove data below a threshold level of resolution, the lidargraph file size can be further reduced. For example, any data below the centimeter level of resolution can be removed to dramatically reduce the lidargraph file size.

### BRIEF DESCRIPTION OF THE DRAWINGS

FIG. 1 is a view of a representative frame of lidar point cloud data showing the bounded grid with the positions of nine objects shown.

FIG. 2 is a simplified bounded grid with three example objects and an index showing the relative and absolute offset of each of the three objects.

### DETAILED DESCRIPTION OF THE INVENTION

While this invention may be embodied in many forms, there are described in detail herein specific embodiments of the invention. This description is an exemplification of the principles of the invention and is not intended to limit the invention to the particular embodiments illustrated.

For the purposes of this disclosure, like reference numerals in the figures shall refer to like features unless otherwise indicated.

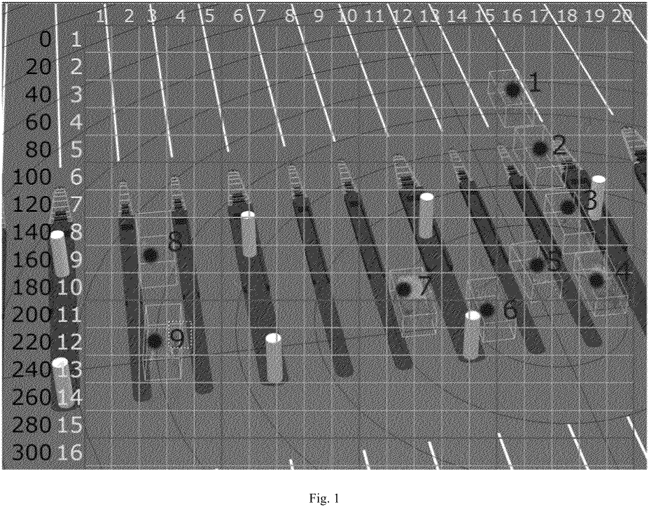

Referring now to FIG. 1, which shows the locations of numerous objects, the positions of which are derived from lidar point cloud data. The point clouds are shown as the little green and red dots inside a yellow cuboids, and are identifiable in a polar coordinate system (the circles emanating from the origin in the lower right of FIG. 1). This 3d cartesian coordinate space (x,y,z) has resolution down to half a centimeter, with the location of each of those red and green points having an x,y, and z value measured as a distance from that origin.

The cuboids (the yellow rectangular 3d boxes) represent objects (vehicles, or pedestrians or buildings or any other object type) that has been identified in the point cloud data. Each of those objects has a centroid (x,y,z) position marked in blue in the same coordinate space. The blue numbers are added identifiers for each object and can be thought of as the ObjectId assigned to each object to be tracked in the lidar data.

FIG. 1 represents one frame of data. Each sequential frame following this one, might have those boxes moving forward as the point clouds built by the lidar move forward.

A bounded grid grid has been overlayed on FIG. 1, with coordinate (1,1) in the upper left corner (base zero), representing how a lidargraph defines its boundaries. While a polar coordinate system has nearly limitless x,y, and z values that can be tracked, a lidargraph puts concrete boundaries around the objects it will define positions for in a given frame of data.

Object #1 in this visualization has an x,y location of 16,3. Its Z value is discarded as this is a 2D lidargraph. While each square in the graph represents more than a meter of space, in real world use, a square is 10 cm in width/height. The purpose of the oversized visualization is to provide insight on how a 2D coordinate space is being reduced to a single offset number. That position (16,3) can also be expressed as = (20 - x1)+ ((y2-y1)-1)*20) + x2 + LAST_OFFSET where P2 = (16,3) and P1 = (1,1), which has an absolute offset of 0.

Object #2 here has a location of (17,5) with LAST_OFFSET being the numeric offset value for Object #1.

By expressing the position of each object as it’s offset from the last object in the field of view, we allow the x and y values of each object to be expressed as a single, relatively small number. Because the offset numbers are stored as variable width integers, or varints. A single byte can be used to express an offset under 255, while three bytes are sufficient to express an offset as high as 65545. Tightly clustered objects may be able to describe their offset from the previous object using a single byte. Two bytes are frequently sufficient to an object’s offset, though 4 and 8 byte offset values are available for extremely widespread objects. This approach has the net effect of reducing the storage requirements for object positions from the 8 byte values returned by the lidar to -2 bytes on average, thus reducing the memory requirement to store an object coordinate by 75%.

Using that logic, the 4 bytes required to store an X value and 4 bytes for the Y value for a location of a single object can be reduced to a single number, that is small enough to be expressed in 2 bytes, and sometimes a single byte, yielding a reduction in storage required by ~75% on average.

To further reduce the lidargraph file size, object indexing is used. All objects in the data stream have long keys (4-8 bytes). These identifiers appear with their associated data (x,y,z, etc) in every frame. By including an objectiD lookup in the file format, the first 250 or so indexed objects can be referenced in each frame using a single byte, which further reduces the lidargraph file size.

Resolution reduction is also utilized to further reduce file size. All objects in the datastream store their X,Y, and Z positions using 4 byte floating point integers (some streams use 8 byte doubles), consuming 12-24 bytes to represent every object’s position in space. The resolution is over precise for most real world object tracing applications, providing the centroid of an object at a micrometer level of specificity when almost no rendering engines and consumption applications care about data that is more specific than a decimeter. The specificity of the data produced by the lidar itself can be misleading in that the centroid is a calculation that can easily shift if someone stretches their arm outward, increasing the radius of the space they occupy.

By eliminating data below the centimeter level of resolution we can dramatically reduce the storage requirements of the data without impacting the accuracy and feel of applications which consume the data. 2 bytes integers with a max value of 65,535 (or 655 meters) sufficient storage for even long range lidar applications.

The method uses Frame bounding with varint based ranging to use less filespace for the spatial position data of the objects. All tracked objects within the view of the lidar fall have limits (max/min x and y values for the dataset). Objects within the dataset are sequenced based on their order of appearance in a bounded grid, reading from right to left, top to bottom. Their positions in the grid are described by the algorithm as their integer offset from the previous object in the grid.

All offset values are stored in variable width integers, or varints. A single byte can be used to express an offset under 255, while three bytes are sufficient to express an offset as high as 65545. Tightly clustered objects may be able to describe their offset from the previous object using a single byte. Two bytes are frequently sufficient to an object’s offset, though 4 and 8 byte offset values are available for extremely widespread objects. This approach has the net effect of reducing the storage requirements for object positions from the 8 byte values returned by the lidar to -2 bytes on average, thus reducing the memory requirement to store an object coordinate by 75%.

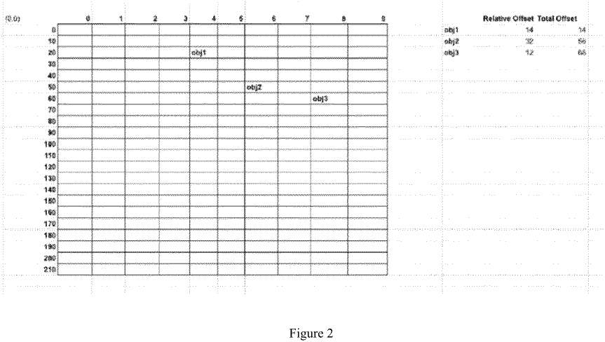

FIG. 2 shows the bounded grid from FIG. 1, with three example objects located and the index of both relative offset and total or absolute offset for each object.

The use of protobuf for serialization of all lidargraph data allows for the end product to be serialized in a reliable, reproducible and most importantly, an extensible manner. If we decide to expand the content of a lidargraph file to include additional object metadata such as size, avg, peak, and min velocity, the floorplan image, or any other thing, the serialization format supports that automatically.

The already compressed lidargraph data still benefits greatly from off the shelf compression tools like Tar and Zip, which can further reduce the storage requirements of the data by as much as 80% (the average compression I have seen is around 60%).

Below are two example of objects that moved to each others exact positions in the time between two frames:

Frame1 positions: [{objId:1,offset:56),(objId:2,offset:41)]
Frame2 positions: [(objId:2,offset:56),(objId:1,offset:41)]

A third object could feasibly make an appearance in future frames. while the other objects could disappear:

Frame3 positions: [(objId:2,offset:58)]
Frame4 positions: [(objId:2,offset:58),(objId:3,offset:235)]

As described above, the first 255 objects utilize object indexes to reduce the size of the lidargraph file. The object ids (1,2,3) that have been using for examples are really object indexes. A cross reference for object index to object ID (and other immutable attributes) is kept in the lidargraph file. Indexes are used because, once again, smaller numbers require fewer bytes to store.

The entire objective here is to make the pre-commercial compression size of the data as small as possible, in a file format that is extensible as possible, to make the data as portable as possible, as cheap to store and replay as possible, so we can feasibly store data for a client into perpetuity at almost no cost.

From a physical storage structure format, arrays of frames are kept, providing a time offset from the starting time of the data, stored in the file header. This allows each frame, based on its indexed location in the list of frames to provide a specific timestamp for the data that frame contains.

Each frame contains an array of objects that are present in the frame. Each element of that array stores the object index, through which the object identifier can be obtained from the object identification array stored in the header of the file, as well as the object offset within a defined 2d or 3d space.

Below is an example of the lidargraph file structure in JSON format:

Timestamp: 20220403T10:13:23z
frameResolution: 1s
offsetResolution: .1m
objects:[22040310132200012001,22040310132200012002,2204031013310
0012001]
sceneBounds:[-100,100,100,100,100,-100,-100,-100]
originLatLong:-33.12312312,92.423221
defaultObjectAttributes: {
class: car
}
frames: [
{
Objects: [
{
objectIdx:0,
offset:48
}]
},
{
Objects: [
{
objectIdx:0,
offset: 200
}]
},
{
Objects: [
{
objectIdx:0,
offset: 220
}]
},
{
Objects: [
{
objectIdx:0,
offset:221
},
{
objectIdx:1,
offset:32
]
},
{
objectIdx:2,
offset:4123
},
],
events: [
{
frameIdx:1,
objectIndexes:[0],
type: ‘enterQueue’
}
],
objectAttributes:[
{
class:person
},
{
class:policeman
},
{
class:person
}
]

The resulting lidargraph is a file format that couples open standard compression (tar, and zip), open standard serialization (protobuf), with the inventive coordinate compression algorithm to produce an output file that contains a time series recording of object positioning data in two or three dimensional space, along with a growing list of related metadata pertaining to the recording, the tracked objects in the recording, and anything else we decide to add.

In addition to storing object spatial data, the lidargraph file can also store immutable attributes about objects (things that don’t change), such as object classification data, for example the object is a vehicle. Mutable data can also be stored (object attributes for example are dynamic). For example, a per frame data about an object like its orientation. It will likely be added as another top level array, associated to the objects indexed in the frame list, for each frame. Event data would also be a per frame datam about an object, such as a door opening or other desired event to track.

Other applications could be to apply the inventive method to file types other than lidar point cloud data. For example, a recorded session of a 3D video game play from a game like Fortnite, to keep track of all players in 3D space, their positions, their orientation, their gear and other desired items like events.

What is claimed is:

1. A method of lossless compression of a file of lidar point cloud data comprising the steps of:
providing a file of lidar data, representing a predetermined number of frames of raw lidar data, with a set of objects identified and classified within the lidar data;
assigning each identified object an objectId to allow tracking of each identified object’s position in each frame;
for each frame of lidar point cloud data, sequencing the position of each identified object in that frame based on each objects order of appearance in a bounded grid applied to each frame, reading from right to left, top to bottom, with each identified objects position described as their integer offset from the previous identified object in the bounded grid;
wherein each identified objects offset value is stored in the compressed file as a variable width integer datatype.

2. The method of lossless compression of claim 1 wherein the compressed position data for each object in each frame is further compressed using an additional lossless compression technique to result in the lidargraph compressed file.

3. The method of lossless compression of claim 1 wherein the position of each object is 2D, or (X, Y).

4. The method of lossless compression of claim 1 wherein the position of each object is 3D, or (X, Y, Z).

5. The method of lossless compression of claim 1 wherein the zero based relative offset for the second object position (x2, y2) relative to the first object position (x1, y1) is (20 - x1) + ((y2-y1)-1)*20) + x2.

6. The method of lossless compression of claim 5 wherein the zero based absolute offset for the second object position is its relative offset plus the relative offset of the first object position.

7. The method of lossless compression of claim 1 wherein object indexing is utilized for the first 255 objects to further reduce the lidargraph file size.

8. The method of lossless compression of claim 1 where resolution reduction is utilized to remove data below a threshold level of resolution, the lidargraph file size can be further reduced.

9. The method of lossless compression of claim 8 wherein the threshold is the centimeter level of resolution.
